(19) United States
(12) Patent Application Publication
(10) Pub. No.: US 2026/0025703 A1
(43) Pub. Date: Jan. 22, 2026

(54) BUFFER STATUS REPORTING

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/251,717

(22) Filed: Jun. 26, 2025

Related U.S. Application Data
(60) Provisional application No. 63/673,562, filed on Jul. 19, 2024.
(60) Provisional application No. 63/693,497, filed on Sep. 11, 2024.

(51) Int. Cl. H04W 28/02; H04W 72/21

(52) U.S. Cl. CPC H04W 28/0278; H04W 72/21

(57) ABSTRACT

A user equipment (UE) UE includes a transceiver, and a processor operably coupled to the transceiver. The transceiver is configured to receive, from a base station (BS), a first configuration allocating uplink (UL) resources for transmitting a buffer status report, and receive, from the BS, a second configuration allocating UL resources for transmitting an indication corresponding to the buffer status report. The processor is configured to select a first UL resource allocated by the first configuration, and select a second UL resource allocated by the second configuration. The transceiver is further configured to transmit the indication corresponding to the buffer status report in the second UL resource, and transmit the buffer status report in the first UL resource.

### CROSS-REFERENCE TO RELATED APPLICATIONS AND CLAIM OF PRIORITY

This application claims priority under 35 U.S.C. § 119(e) to U.S. Provisional Patent Application No. 63/673,562 filed on Jul. 19, 2024, and U.S. Provisional Patent Application No. 63/693,497 filed on Sep. 11, 2024. The above-identified provisional patent applications are hereby incorporated by reference in their entirety.

### TECHNICAL FIELD

This disclosure relates generally to wireless networks. More specifically, this disclosure relates to buffer status reporting.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for buffer status reporting.

In one embodiment, a user equipment (UE) is provided. The UE includes a transceiver, and a processor operably coupled to the transceiver. The transceiver is configured to receive, from a base station (BS), a first configuration allocating uplink (UL) resources for transmitting a buffer status report, and receive, from the BS, a second configuration allocating UL resources for transmitting an indication corresponding to the buffer status report. The processor is configured to select a first UL resource allocated by the first configuration, and select a second UL resource allocated by the second configuration. The transceiver is further configured to transmit the indication corresponding to the buffer status report in the second UL resource, and transmit the buffer status report in the first UL resource.

In another embodiment, a BS is provided. The BS includes a processor, and a transceiver operably coupled to the processor. The transceiver is configured to transmit, to a user UE, a first configuration allocating UL resources for transmitting a buffer status report, and transmit, to the UE, a second configuration allocating UL resources for transmitting an indication corresponding to the buffer status report. The transceiver is further configured to receive an indication corresponding to the buffer status report in a second UL resource allocated by the second configuration, and receive the buffer status report in a first UL resource allocated by the first configuration.

In yet another embodiment, a method of operating a UE is provided. The method includes receiving, from BS, a first configuration allocating UL resources for transmitting a buffer status report, and receiving, from the BS, a second configuration allocating UL resources for transmitting an indication corresponding to the buffer status report. The method also includes selecting a first UL resource allocated by the first configuration, and selecting a second UL resource allocated by the second configuration. The method also includes transmitting the indication corresponding to the buffer status report in the second UL resource, and transmitting the buffer status report in the first UL resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for buffer status reporting according to embodiments of the present disclosure;

FIG. 5 illustrates an example of PUSCH utilization/allocation according to embodiments of the present disclosure;

FIG. 6 illustrates an example of a resource selected by a UE from a first and second configuration for a BSR according to embodiments of the present disclosure;

FIG. 7 illustrates an example procedure for delay status reporting according to embodiments of the present disclosure;

FIG. 8 illustrates an example procedure for determining PDCCH monitoring occasions for paging according to embodiments of the present disclosure;

FIG. 9 illustrates an example procedure for determining PDCCH monitoring occasions for RAR according to embodiments of the present disclosure;

FIG. 10 illustrates an example procedure for determining PDCCH monitoring occasions for paging early indication according to embodiments of the present disclosure;

FIG. 11 illustrates an example procedure for determining PDCCH monitoring occasions for OSI according to embodiments of the present disclosure;

FIG. 12 illustrates an example procedure for determining PDCCH monitoring occasions for MCCH according to embodiments of the present disclosure;

FIG. 13 illustrates an example procedure for determining PDCCH monitoring occasions for MTCH according to embodiments of the present disclosure;

FIG. 14 illustrates an example method for buffer status reporting according to embodiments of the present disclosure; and

FIG. 15 illustrates another example method for buffer status reporting according to embodiments of the present disclosure.

### DETAILED DESCRIPTION

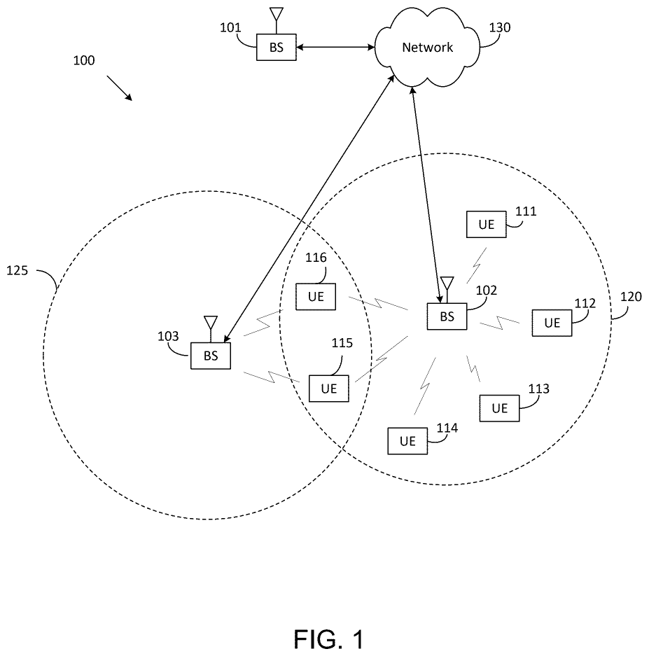

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for buffer status reporting. In certain embodiments, one or more of the gNBs 101-103 includes circuitry, programing, or a combination thereof, to support buffer status reporting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

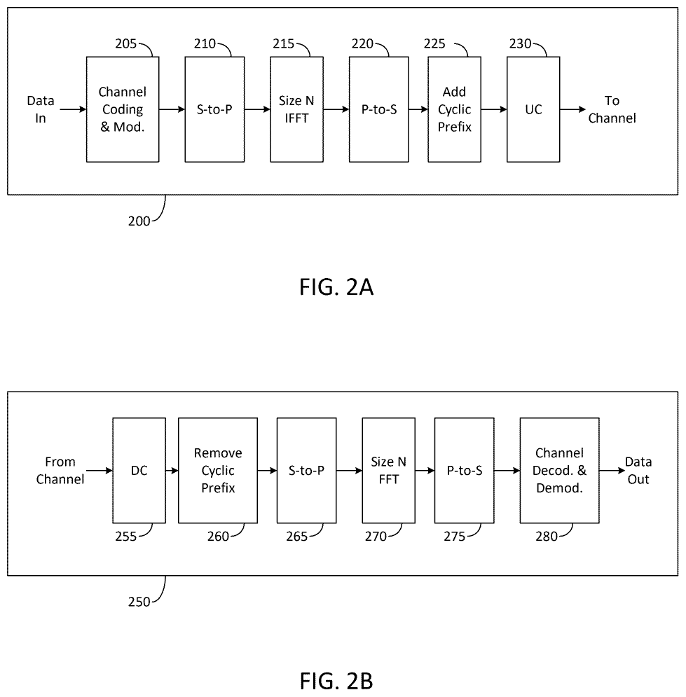

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support buffer status reporting as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

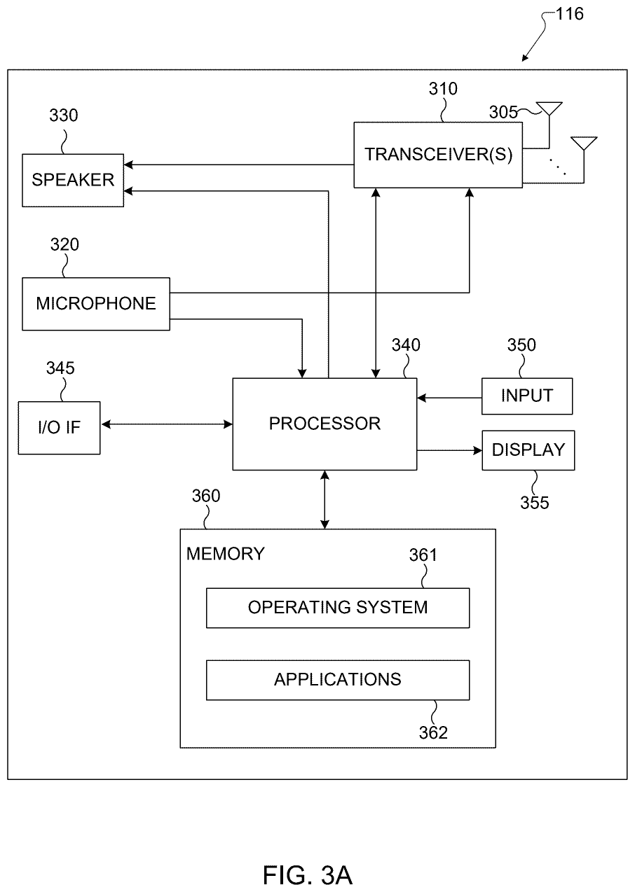

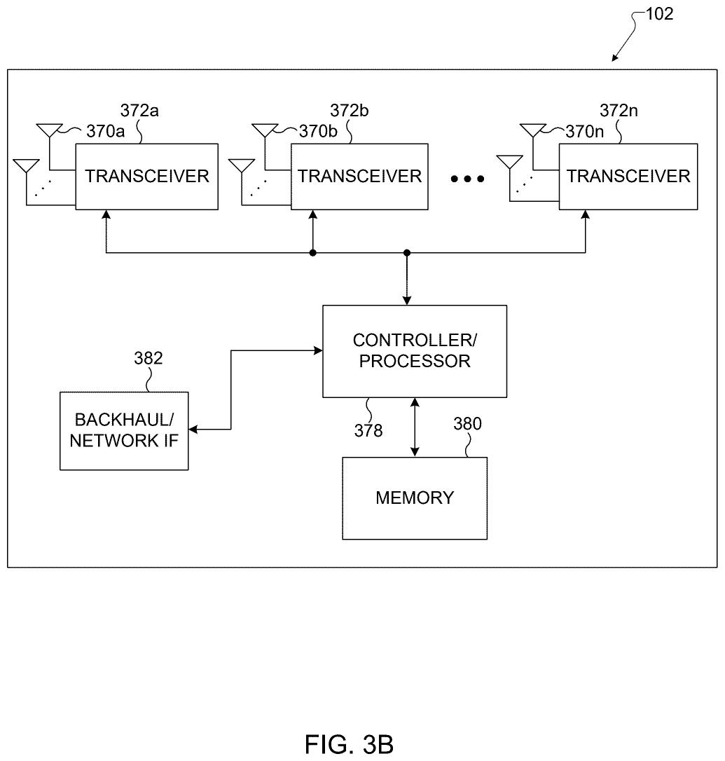

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for buffer status reporting as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support buffer status reporting as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC CONNECTED state. Several types of RA procedures are supported, such as contention based random access, and contention free random access. Each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G (B5G), 6G), a UE can be in one of the following RRC states: RRC IDLE, RRC INACTIVE and RRC CONNECTED. Paging allows the network to reach UEs in the RRC_IDLE and in RRC_INACTIVE state through Paging messages, and to notify UEs in the RRC_IDLE, RRC_INACTIVE and RRC_CONNECTED state of system information changes and ETWS (Earthquake and Tsunami Warning System)/CMAS (Commercial Mobile Alert System) indications through Short Messages. Both Paging messages and Short Messages are addressed with a paging radio network terminal identifier (P-RNTI) on the PDCCH, but while the former is sent on a paging common logical channel (PCCH) (a transport block [TB] carrying the paging message is transmitted over the PDSCH [Physical downlink shared channel])), the latter is sent over the PDCCH directly.

While in the RRC_IDLE state, the UE monitors the paging channels for core network (CN)-initiated paging. While in the RRC_INACTIVE state, the UE monitors paging channels for radio access network (RAN)-initiated paging and CN-initiated paging. A UE need not monitor paging channels continuously though. Paging discontinuous reception (DRX) is defined where the UE in the RRC_IDLE or RRC_INACTIVE state is only required to monitor paging channels during one Paging Occasion (PO) per DRX cycle.

A PO is a set of PDCCH monitoring occasions and can comprise multiple time slots (e.g., subframes or OFDM symbols) where paging DCI (i.e., PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams, and thus the selection of the beam(s) for the reception of the paging message and Short Message is up to UE implementation. The paging message is the same for both RAN initiated paging and CN initiated paging. The UE initiates the RRC Connection Resume procedure upon receiving RAN initiated paging. If the UE receives a CN initiated paging in the RRC_INACTIVE state, the UE moves to the RRC_IDLE state and informs the network access stratum (NAS).

The PF and PO for paging are determined (by the UE and base station e.g., gNB) by the following formulae:
System frame number (SFN) for the PF is determined by:

$$( SFN + PF\_offset ) mod T = ( T div N ) * ( UE\_ID mod N )$$

Index (is), indicating the index of the PO is determined by:

$$i\_s = floor ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI (or SIB1).

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (is =0) or the second half frame (is =1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of thefirstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:
If the UE operates in enhanced DRX (eDRX):
   5G-S-TMSI (5G serving temporary mobile subscriber identity) mod 4096 otherwise:

$$5 G - S - TMSI mod 1024$$

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and is formulas above.

In order to reduce UE power consumption due to false paging alarms, the group of UEs monitoring the same PO can be further divided into multiple subgroups. With subgrouping, a UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

Paging with CN assigned subgrouping is used in the cell which supports CN assigned subgrouping. A UE supporting CN assigned subgrouping in the RRC_IDLE or RRC_INACTIVE state can be assigned a subgroup ID (between 0 to 7) by an access and mobility management function (AMF) through NAS signaling.

If the UE is not configured with a CN assigned subgroup ID, or if the UE configured with a CN assigned subgroup ID is in a cell supporting only UE_ID based subgrouping, the subgroup ID of the UE is determined by the formula below:

$$SubgroupID = ( floor ( U E\_ID / ( N ⋆ Ns ) ) mod subgroupsNumForUEID ) + ( subgroupsNumPerPO - subgroupsNumForUEID ) ,$$

where:
   N: number of total paging frames in T, which is the DRX cycle of RRC_IDLE state
   Ns: number of paging occasions for a PF
   UE_ID: 5G-S-TMSI mod X, where X is 32768, if eDRX is applied; otherwise, X is 8192 subgroupsNumForUEID: number of subgroups for UE_ID based subgrouping in a PO, which is broadcasted in system information.

The UE monitors one PEI occasion per DRX cycle. A PEI occasion (PEI-O) is a set of PDCCH monitoring occasions (MOs) and can comprise multiple time slots (e.g., subframes or OFDM symbols) where a PEI can be sent. In multi-beam operations, the UE assumes that the same PEI is repeated in all transmitted beams, and thus the selection of the beam(s) for the reception of the PEI is up to UE implementation. The time location of a PEI-O for the UE's PO is determined by a reference point and an offset:
The reference point is the start of a reference frame determined by a frame-level offset from the start of the first PF of the PF(s) associated with the PEI-O, provided by pei-FrameOffset in SIB1; The first PF of the PFs associated with the PEI-O is provided by (SFN for PF)—floor (i_{PO}/Ns)*T/N; where

$${i}_{P O} = ( ( UE\_IDmod N ) \cdot {N}_{S} + i\_s ) mod {N}_{PO}^{PEI}$$

is a paging occasion index,

$${N}_{PO}^{PEI} ,$$

is signaled by po-NumPerPEI.
The offset is a symbol-level offset from the reference point to the start of the first PDCCH MO of this PEI-O, provided byfirstPDCCH-MonitoringOccasionOfPEI-O in SIB1.

In existing wireless communication systems, measurement reports are used to enable the scheduler to operate in both uplink and downlink. These measurement reports include transport volume and measurements of a UEs radio environment. Uplink buffer status reports (BSRs) are used to provide support for QoS-aware packet scheduling. Uplink BSRs refer to the data that is buffered for a group of logical channels (LCG) in the UE. Uplink BSRs are transmitted using MAC signaling.

When a BSR is triggered (e.g., when new data arrives in the transmission buffers of the UE), a Scheduling Request (SR) can be transmitted by the UE (e.g., when no resources are available to transmit the BSR). The network schedules an UL grant upon receiving an SR. The UE receives the UL grant. The UE transmits the BSR in UL grant. The network schedules a dynamic UL grant based on the BSR. This procedure delays the transmission of the BSR.

A delay status report (DSR) is triggered for an LCG when the remaining time before discard of any buffered PDCP SDU goes below a configured threshold (a threshold configured per LCG by the gNB). When triggered for an LCG, the DSR reports the amount of data buffered with a remaining time before discard below the configured threshold, together with the shortest remaining time of any PDCP SDU buffered. When a DSR is triggered, an SR can be transmitted by the UE (e.g., when no resources are available to transmit the DSR). The network schedules a UL grant upon receiving the SR. The UE receives the UL grant. The UE transmits the DSR in the UL grant. The network schedules a dynamic UL grant based on the DSR. This procedure delays the transmission of the DSR.

Similar issues occur for transmitting a beam failure recovery report, power headroom report, LBT failure report, etc. Various embodiments of the present disclosure provide mechanisms for transmission of BSRs, DSRs, beam failure recovery reports, power headroom reports, LBT failure reports, etc. with reduced delay.

For a UE to receive paging in a BWP of a cell, the network (e.g., a gNB) signals a parameter/field/information element pagingSearchSpace in the configuration of that BWP. The BWP configuration is signaled in system information (e.g., SIB1) and/or an RRC message (e.g., an RRCReconfiguration message). The parameter/field/information element pagingSearchSpace can be set to zero or non-zero value.

If the parameter/field/information element pagingSearchSpace is set to 0, the UE determines PDCCH monitoring occasions for paging based on the parameters SearchSpaceZero and controlResourceSetZero included in the MIB.

In a cell, when SIB1 is provided on demand (i.e., based on a SIB1 request), SearchSpaceZero and controlResourceSetZero are not included in the MIB. As a result, when SIB1 is provided on demand, the UE cannot determine PDCCH monitoring occasions for paging for the case where pagingSearchSpace is set to 0. Various embodiments of the present disclosure provide mechanisms for a UE to determine PDCCH monitoring occasions for paging for the case where pagingSearchSpace is set to 0 when SIB1 is provided on demand.

During a random access procedure, a UE should receive a RAR after transmitting the random access preamble. For the UE to receive a RAR in a BWP of a cell, the network (e.g., a gNB) signals a parameter/field/information element rarSearchSpace in the configuration of that BWP. The BWP configuration is signaled in system information (e.g., SIB1) and/or an RRC message (e.g., a RRCReconfiguration message). The parameter/field/information element rarSearchSpace can be set to zero or non-zero value.

If the parameter/field/information element rarSearchSpace is set to 0, the UE determines PDCCH monitoring occasions for RAR based on the parameters SearchSpaceZero and controlResourceSetZero included in the MIB.

In a cell, when SIB1 is provided on demand (i.e., based on a SIB1 request), SearchSpaceZero and controlResourceSetZero are not included in the MIB. As a result, when SIB1 is provided on demand, the UE cannot determine PDCCH monitoring occasions for a RAR for the case where rarSearchSpace is set to 0. Various embodiments of the present disclosure provide mechanisms for a UE to determine PDCCH monitoring occasions for a RAR for the case where rarSearchSpace is set to 0 when SIB1 is provided on demand.

For UE to receive other system information (OSI) (i.e., SIBs other than SIB1) in a BWP of a cell, the network (e.g., gNB) signals a parameter/field/information element searchSpaceOtherSystemInformation in the configuration of that BWP. The BWP configuration is signaled in system information (e.g., SIB1) and/or an RRC message (e.g., an RRCReconfiguration message). The parameter/field/information element searchSpaceOtherSystemInformation can be set to zero or non-zero value.

If the parameter/field/information element searchSpaceOtherSystemInformation is set to 0, the UE determines the PDCCH monitoring occasions for the OSI based on the parameters SearchSpaceZero and controlResourceSetZero included in the MIB.

In a cell, when SIB1 is provided on demand (i.e., based on SIB1 request), SearchSpaceZero and controlResourceSetZero are not included in the MIB. As a result, when SIB1 is provided on demand, the UE cannot determine PDCCH monitoring occasions for OSI for the case where searchSpaceOtherSystemInformation is set to 0. Various embodiments of the present disclosure provide mechanisms for a UE to determine PDCCH monitoring occasions for OSI for the case where searchSpaceOtherSystemInformation is set to 0 when SIB1 is provided on demand.

For a UE to receive a paging early indication in a BWP of a cell, the network (e.g., a gNB) signals a parameter/field/information element pei-SearchSpace in the configuration of that BWP. The BWP configuration is signaled in system information (e.g., SIB1) and/or an RRC message (e.g., an RRCReconfiguration message). The parameter/field/information element pei-SearchSpace can be set to zero or non-zero value.

If the parameter/field/information element pei-SearchSpace is set to 0, UE determines PDCCH monitoring occasions for paging early indication based on parameters SearchSpaceZero and controlResourceSetZero included in the MIB.

In a cell, when SIB1 is provided on demand (i.e., based on a SIB1 request), SearchSpaceZero and controlResourceSetZero are not included in the MIB. As a result, when SIB1 is provided on demand, the UE cannot determine PDCCH monitoring occasions for paging early indication for the case where pei-SearchSpace is set to 0. Various embodiments of the present disclosure provide mechanisms for a UE to determine PDCCH monitoring occasions for paging early indication for the case where pei-SearchSpace is set to 0 when SIB1 is provided on demand.

For a UE to receive Multicast Common Control Channel (MCCH) in a cell, the network (e.g., a gNB) signals a parameter/field/information element searchSpaceMulticastMCCH. The parameter/field/information element searchSpaceMulticastMCCH can be set to zero or non-zero value.

If the parameter/field/information element searchSpaceMulticastMCCH is set to 0, the UE determines the PDCCH monitoring occasions for MCCH based on the parameters SearchSpaceZero and controlResourceSetZero included in the MIB.

In a cell, when SIB1 is provided on demand (i.e., based on a SIB1 request), SearchSpaceZero and controlResourceSetZero are not included in the MIB. As a result, when SIB1 is provided on demand, the UE cannot determine PDCCH monitoring occasions for MCCH for the case where searchSpaceMulticastMCCH is set to 0. Various embodiments of the present disclosure provide mechanisms for a UE to determine PDCCH monitoring occasions for MCCH for the case where searchSpaceMulticastMCCH is set to 0 when SIB1 is provided on demand.

For a UE to receive Multicast Common Traffic Channel (MTCH) in a cell, the network (e.g., gNB) signals a parameter/field/information element searchSpaceMulticastMTCH. The parameter/field/information element searchSpaceMulticastMTCH can be set to zero or non-zero value.

If the parameter/field/information element searchSpaceMulticastMTCH is set to 0, the UE determines the PDCCH monitoring occasions for MTCH based on the parameters SearchSpaceZero and controlResourceSetZero included in the MIB.

In a cell, when SIB1 is provided on demand (i.e., based on a SIB1 request), SearchSpaceZero and controlResourceSetZero are not included in the MIB. As a result, when SIB1 is provided on demand, the UE cannot determine PDCCH monitoring occasions for MTCH for the case searchSpaceMulticastMTCH is set to 0. Various embodiments of the present disclosure provide mechanisms for a UE to determine PDCCH monitoring occasions for MTCH for the case where searchSpaceMulticastMTCH is set to 0 when SIB1 is provided on demand.

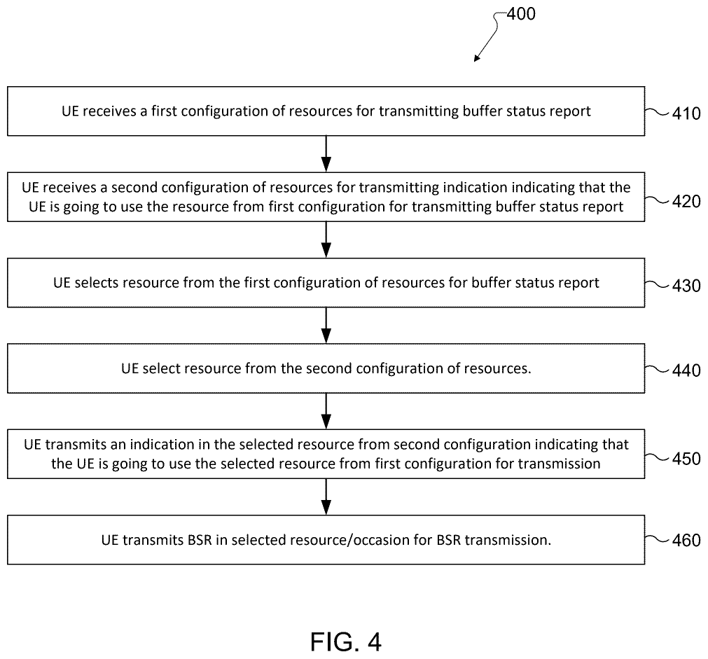

FIG. 4 illustrates an example procedure 400 for buffer status reporting according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for buffer status reporting could be used without departing from the scope of this disclosure.

In the example of FIG. 4, procedure 400 begins at operation 410. At operation 410, a UE (such as UE 116 of FIG. 1) receives (e.g., in an RRC message or system information or MAC CE or DCI) a first configuration of resources for transmitting a buffer status report from a gNB (base station or cell or CU or DU, etc.). In some embodiments, the resources can be PUSCH resources (or PUCCH resources). The configuration indicates a periodic occurrence of the resource/occasion for transmitting the BSR. The configuration also indicates frequency domain resources (e.g., a starting PRB #/index, number of PRBs, last PRB index, etc.) and time domain resources (e.g., OFDM symbols) for each resource/occasion. Each of these resources/occasions for transmitting the BSR can also be a configured grant (CG).

At operation 420, the UE receives (e.g., in an RRC message or system information or MAC CE or DCI) a second configuration of resources for transmitting an indication. The resources for the indication can be PUCCH resources or any other uplink control channel resource or PUSCH resource. The first and second configuration may be received together in same message (e.g., in an RRC message or system information or MAC CE or DCI) or separately.

At operation 430, a BSR is triggered, and the UE selects a resource/occasion based on the first configuration of resources for buffer status reporting. The UE may select a nearest (in time) available resource/occasion for transmitting the buffer status report or the UE may select the first available resource/occasion for transmitting the buffer status report after an offset (the offset may be pre-defined or configured based on processing time needed to prepare the BSR or a MAC PDU including the BSR or a TB including the BSR for transmission on resource/occasion). The UE may select a resource/occasion for transmitting the buffer status report for which the associated resource for transmitting the indication occurs after the BSR is triggered.

At operation 440, the UE selects a resource/occasion based on the second configuration of resources. This selected resource occurs before the resource selected for the BSR transmission. This selected resource may be the latest available resource before the resource selected for the BSR transmission, or this selected resource may be the latest available resource before an offset from the resource selected for the BSR transmission or this selected resource may be the resource associated with the resource selected for BSR transmission.

At operation 450, the UE transmits an indication in this selected resource from the second configuration indicating that the UE is going to use the resource/occasion from the first configuration for transmission or the UE is going to transmit in the selected resource/occasion from first configuration. In some embodiments, resources for the indication may be configured such that there is one resource for the indication for every resource/occasion configured for the BSR transmission. In some embodiments, resources for the indication may be configured such that there are multiple resources for the indication for every resource/occasion configured for the BSR transmission. In some embodiments, resources for the indication may be configured such that there is one resource for the indication for multiple resources/occasions configured for the BSR transmission. In case there is one resource for indication corresponding to multiple resources/occasions configured for BSR transmission, the UE may indicate in the indication which resource(s)/occasion(s) for the BSR transmission the UE is going to use for the transmission. Resource(s)/occasion(s) for BSR transmission corresponding to a resource for the indication can be sequentially indexed and the index can be indicated in an indication (e.g., using a bit map wherein each bit maps to a different index) or index values can be explicitly indicated in the indication.

At operation 460, the UE transmits the BSR in the selected resource/occasion for the BSR transmission.

Although FIG. 4 illustrates one example procedure 400 for buffer status reporting, various changes may be made to FIG. 4. For example, while shown as a series of operations, various operations in FIG. 4 could overlap, occur in parallel, occur in a different order, occur any number of times, be omitted, or be replaced by other operations.

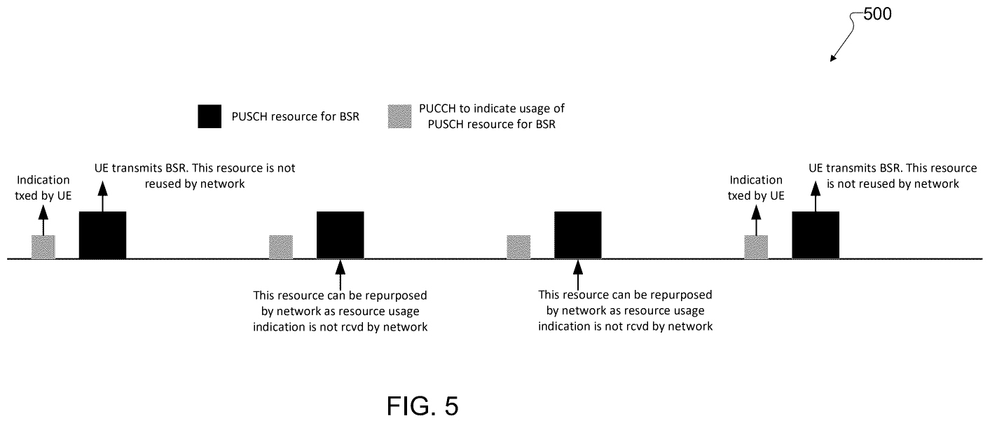

During procedure 400, upon signaling the first and second configuration of resources, the gNB monitors resources of the second configuration. If an indication is received in a resource of the second configuration, the gNB receives and decodes the corresponding resource(s) for the first configuration. If an indication is not received in a resource of the second configuration, the corresponding resource(s) for first configuration can be utilized/allocated by the gNB for other purposes/UEs. This procedure is illustrated in FIG. 5.

FIG. 5 illustrates an example of PUSCH utilization/allocation 500 according to embodiments of the present disclosure. The embodiment of PUSCH utilization/allocation of FIG. 5 is for illustration only. Different embodiments of PUSCH utilization/allocation could be used without departing from the scope of this disclosure.

As shown in the example of FIG. 5, for every PUSCH resource for a BSR, there is also a PUCCH resource. If an indication from the UE is not received in a PUCCH resource corresponding to a PUSCH resource, that PUSCH resource can be utilized/allocated by the gNB for other purposes/UEs. If an indication from the UE is not received in a PUCCH resource corresponding to a PUSCH resource, the gNB does not decode the PUSCH in that resource.

Although FIG. 5 illustrates one example of PUSCH utilization/allocation 500, various changes may be made to FIG. 5. For example, various changes to correspondences between the resources could be made, etc. according to particular needs.

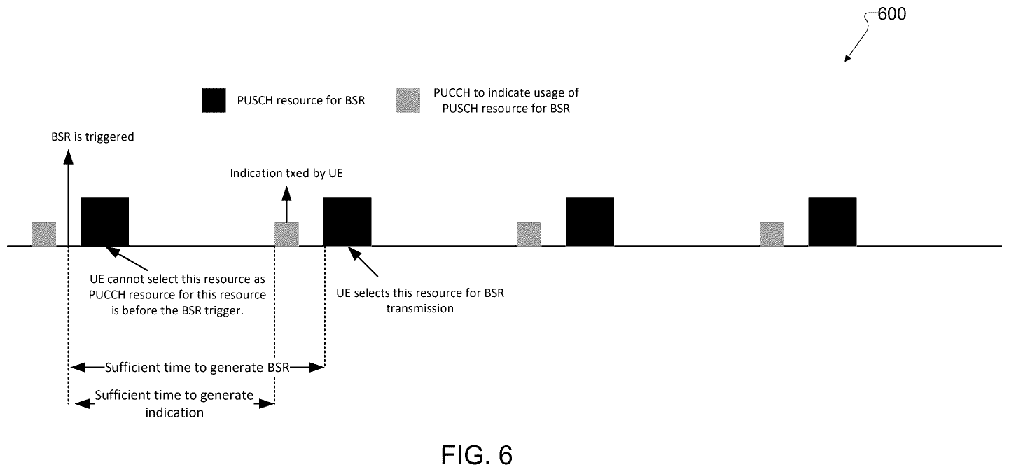

FIG. 6 illustrates an example of a resource selected by a UE from a first and second configuration for a BSR 600 according to embodiments of the present disclosure. The embodiment of resource selection of FIG. 6 is for illustration only. Different embodiments of a resource selected by a UE from a first and second configuration for a BSR could be used without departing from the scope of this disclosure.

In the example of FIG. 6, a first configuration signals a PUSCH resource for BSR, and a second configuration signals a PUCCH resource for indication, similar as described regarding procedure 400 of FIG. 4. For every PUSCH resource for a BSR there is a corresponding PUCCH resource. The first available PUSCH resource for a BSR after the BSR triggered is not selected by UE, as the PUCCH resource for this resource occurred in the past (i.e., the PUCCH resource occurred before the BSR trigger). If the UE selects this resource, the UE is unable to transmit the indication. Therefore, the UE selects the next PUSCH resource and the corresponding PUCCH resource so that there is sufficient time to generate the BSR/TB including the BSR and there is sufficient time to generate the indication.

Although FIG. 6 illustrates one example of a resource selected by a UE from a first and second configuration for a BSR 600, various changes may be made to FIG. 6. For example, various changes to correspondences between the resources could be made, etc. according to particular needs.

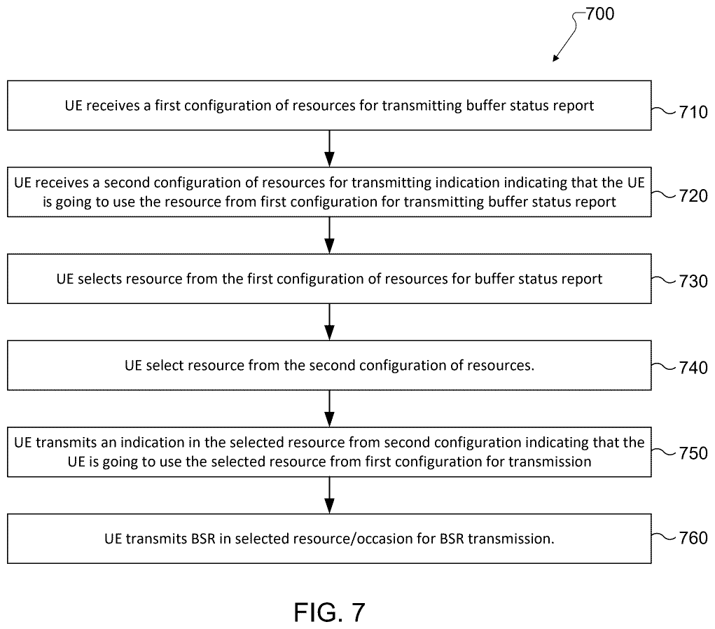

FIG. 7 illustrates an example procedure 700 for delay status reporting according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for buffer status reporting could be used without departing from the scope of this disclosure.

In the example of FIG. 7, procedure 700 begins at operation 710. At operation 710, a UE (such as UE 116 of FIG. 1) receives (e.g., in an RRC message or system information or MAC CE or DCI) a first configuration of resources for transmitting a delay status report from a gNB (base station or cell or CU or DU, etc.). In some embodiments, the resources can be PUSCH resources (or PUCCH resources). The configuration indicates a periodic occurrence of a resource/occasion for transmitting the DSR. The configuration also indicates frequency domain resources (e.g., a starting PRB #/index, number of PRBs, last PRB index, etc.) and time domain resources (e.g., OFDM symbols) for each resource/occasion. Each of these resources/occasions for transmitting the DSR can also be a configured grant.

At operation 720, the UE receives (e.g., in an RRC message or system information or MAC CE or DCI) a second configuration of resources for transmitting an indication. The resources for the indication can be PUCCH resources or any other uplink control channel resource or PUSCH resource. The first and second configuration may be received together in same message (e.g., in an RRC message or system information or MAC CE or DCI) or separately.

At operation 730, a DSR is triggered, and the UE selects a resource/occasion based on the first configuration of resources for delay status reporting. The UE may select a nearest (in time) available resource/occasion for transmitting the delay status report or UE the may select the first available resource/occasion for transmitting the delay status report after an offset (the offset may be pre-defined or configured based on the processing time needed to prepare the DSR or a MAC PDU including the DSR or a TB including the DSR for transmission on the resource/occasion). The UE may select a resource/occasion for transmitting the delay status report for which the associated resource for transmitting the indication occurs after the DSR is triggered.

At operation 740, the UE selects a resource/occasion based on the second configuration of resources. This selected resource occurs before the resource selected for DSR transmission. This selected resource may be the latest available resource before the resource selected for DSR transmission, or this selected resource may be the latest available resource before an offset from the resource selected for DSR transmission or this selected resource may be the resource associated with the resource selected for DSR transmission.

At operation 750, the UE transmits an indication in this selected resource from the second configuration indicating that the UE is going to use the resource/occasion from the first configuration for transmission or the UE is going to transmit in the selected resource/occasion from the first configuration. In some embodiments, the resources for the indication may be configured such that there is one resource for the indication for every resource/occasion configured for the DSR transmission. In some embodiments, the resources for the indication may be configured such that there are multiple resources for the indication for every resource/occasion configured for the DSR transmission. In some embodiments, the resources for indication may be configured such that there is one resource for indication for multiple resources/occasions configured for the DSR transmission. In case there is one resource for indication corresponding to multiple resources/occasions configured for DSR transmission, the UE may indicate in the indication which resource(s)/occasion(s) for DSR transmission the UE is going to use for transmission. The resource(s)/occasion(s) for DSR transmission corresponding to a resource for indication can be sequentially indexed and the index can be indicated in the indication (e.g., using bit map wherein each bit maps to a different index) or index values can be explicitly indicated in the indication.

At operation 760, the UE transmits DSR in the selected resource/occasion for DSR transmission.

Although FIG. 7 illustrates one example procedure 700 for delay status reporting, various changes may be made to FIG. 7. For example, while shown as a series of operations, various operations in FIG. 7 could overlap, occur in parallel, occur in a different order, occur any number of times, be omitted, or be replaced by other operations.

In some embodiments, the first configuration of resources for transmitting a BSR and DSR can be the same resources. In some embodiments, the first configuration of resources for transmitting a BSR and DSR can be different resources. In some embodiments, the second configuration of resources for transmitting an indication for a BSR and DSR can be the same resources. In some embodiments, the second configuration of resources for transmitting an indication for a BSR and DSR can be different resources.

In some embodiments, a first configuration of resources for various types of transmissions/reports (e.g., BSR, DSR, BFR, LBT failure, PHR, data from logical channel(s), PDCP status report, RLC feedback report, etc.) can be the same or can be commonly configured. In these embodiments, a UE may receive (e.g., in an RRC message or system information or MAC CE or DCI) a first configuration of resources from a gNB (base station or cell or CU or DU, etc.). In some embodiments, the resources can be PUSCH resources (or PUCCH resources). The configuration indicates the periodic occurrence of a resource/occasion. The configuration also indicates frequency domain resources (e.g., a starting PRB #/index, number of PRBs, last PRB index, etc.) and time domain resources (e.g., OFDM symbols) for each resource/occasion. Each of these resources/occasions can also be a configured grant. These resource/occasions are used for various types of transmissions (e.g., BSR, DSR, BFR, LBT failure, PHR, data from logical channel(s), PDCP status report, RLC feedback report, etc.). In some embodiments, the gNB can signal which types of transmissions/reports are allowed to be transmitted in the resources of first configuration.

In some embodiments, The UE may receive (e.g., in an RRC message or system information or MAC CE or DCI) a second configuration of resources for transmitting an indication. The resources for the indication can be PUCCH resources or any other uplink control channel resource or PUSCH resource. In some embodiments, the resources for indication in the second configuration may be configured such that there is one resource for the indication for every resource/occasion configured by first configuration. In some embodiments, the resources for indication in the second configuration may be configured such that there are multiple resources for the indication for every resource/occasion configured by first configuration. In some embodiments, the resources for indication may be configured in the second configuration such that there is one resource for indication for multiple resources/occasions configured by the first configuration. In case there is one resource for indication corresponding to multiple resources/occasions configured by first configuration, the UE may indicate in the indication which resource(s)/occasion(s) configured by first configuration the UE is going to use for transmission. The resource(s)/occasion(s) configured by first configuration corresponding to a resource for indication in second configuration can be sequentially indexed and index can be indicated in indication e.g., using bit map wherein each bit maps to a different index or index values can be explicitly indicated in the indication.

In some embodiments, a priority of each type of transmission associated with the resource/occasion configured by the first configuration can be configured or pre-defined. In case multiple types of transmissions/reports are pending at the same time, and all the transmissions/reports cannot be transmitted in the same resource/occasion, the UE can prioritize based on the decreasing order of priority (highest to lowest). As long as at least one type of transmission/report is transmitted in a resource configured by the first configuration, the UE transmits an indication in the corresponding resource configured by the second configuration before the transmission in the resource configured by first configuration.

In some embodiments, when a type of transmission/report allowed to be transmitted in resources of the first configuration is triggered (and is pending) the UE may select a resource/occasion based on the first configuration of resources.

In some embodiments, the UE may select a resource/occasion based on the second configuration of resources.

In some embodiments, the UE may transmit an indication in this selected resource from the second configuration indicating that the UE is going to use the resource/occasion from the first configuration for transmission or the UE is going to transmit in the selected resource/occasion from the first configuration. In some embodiments, a size of the TB/MAC PDU/report to be transmitted in the resource/occasion from the first configuration can also be indicated. In some embodiments, there can be multiple first configurations of resources, wherein a resource size in each of these first configurations can be different. The UE can select a first configuration amongst these multiple first configurations of resources based on a size of resource and amounts of data to be transmitted by the UE. The first configuration amongst these multiple first configurations selected by the UE can be indicated in the indication. In some embodiments, the types of transmissions/reports to be transmitted in the resource/occasion from the first configuration can be indicated in the indication.

In some embodiments, the UE may transmit the allowed transmission type/report in the selected resource/occasion from first configuration

In some embodiments, several first configurations of resources can be received by a UE from a gNB. In these embodiments, the UE may also receive a second configuration of resources for each of these first configurations of resources. Each of these first configurations of resources can be associated with a certain transmission (e.g., a BSR or DSR or BFR or LBT failure or PHR or data from certain logical channel(s) or PDCP status report or RLC feedback report, etc.). For each of the first configurations, the gNB can signal which type of transmission is allowed to be transmitted in the resources of that first configuration. In some embodiments, the resources can be PUSCH resources (or PUCCH resources or CGs).

In some embodiments, when the UE decides to transmit a transmission allowed to be transmitted in resources of a first configuration, the UE may select a resource/occasion based on that first configuration of resources.

In some embodiments, when the UE decides to transmit a transmission allowed to be transmitted in resources of a first configuration, the UE may select resource/occasion based on the second configuration of resources associated with that first configuration of resources.

In some embodiments, when the UE decides to transmit a transmission allowed to be transmitted in resources of a first configuration, the UE may transmit an indication in this selected resource from second configuration indicating that the UE is going to use the resource/occasion from first configuration for transmission or the UE is going to transmit in the selected resource/occasion from the first configuration.

In some embodiments, when the UE decides to transmit a transmission allowed to be transmitted in resources of a first configuration, the UE may transmit the allowed transmission type/report in the selected resource/occasion of first configuration.

In some embodiments, a UE may receive (e.g., in an RRC message or system information or MAC CE or DCI) a first configuration of DL resources from a gNB (base station or cell or CU or DU etc.). The resources can be PDSCH resources (which can also be referred to as DL configured grants). The configuration indicates a periodic occurrence of a resource/occasion. The configuration also indicates frequency domain resources (e.g., a starting PRB #/index, number of PRBs, last PRB index, etc.) and time domain resources (e.g., OFDM symbols) for each resource/occasion. Each of these resources/occasions can also be a configured grant.

In some embodiments, the UE may receive (e.g., in an RRC message or system information or MAC CE or DCI) a second configuration of resources for receiving an indication. The resources for indication can be PDCCH resources or any other downlink control channel resource or PDSCH resource.

In some embodiments, the UE may monitor the resources of a second configuration. If an indication is received in a resource of the second configuration, the UE may decode the resource(s) corresponding to the resource of the second configuration in which the indication is received or the UE may decode the resource(s) indicated by the indication.

In some embodiments, a DL transmission may be triggered, and a gNB may select a resource/occasion based on the first configuration of resources. The gNB selects the resource/occasion based on the second configuration of resources. This selected resource occurs before the resource selected from the first configuration of resources.

In some embodiments, the gNB may transmit an indication in this selected resource from the second configuration indicating that the gNB is going to use the resource/occasion from the first configuration for transmission or the gNB is going to transmit in the selected resource/occasion from the first configuration. In some embodiments, resources for the indication may be configured such that there is one resource for the indication for every resource/occasion in the first configuration. In some embodiments, resources for the indication may be configured such that there is one resource for the indication for multiple resources/occasions in the first configuration. In some embodiments, resources for the indication may be configured such that there are multiple resources for the indication for multiple resources/occasions in the first configuration. In case there is one resource for indication corresponding to multiple resources/occasions in the first configuration, the gNB may indicate in the indication which resource(s)/occasion(s) in the first configuration the gNB is going to use for transmission. Resource(s)/occasion(s) in the first configuration corresponding to a resource for indication can be sequentially indexed and the index can be indicated in the indication (e.g., using a bit map wherein each bit maps to a different index) or index values can be explicitly indicated in the indication.

In some embodiments, the gNB may transmit in the selected resource/occasion from first configuration.

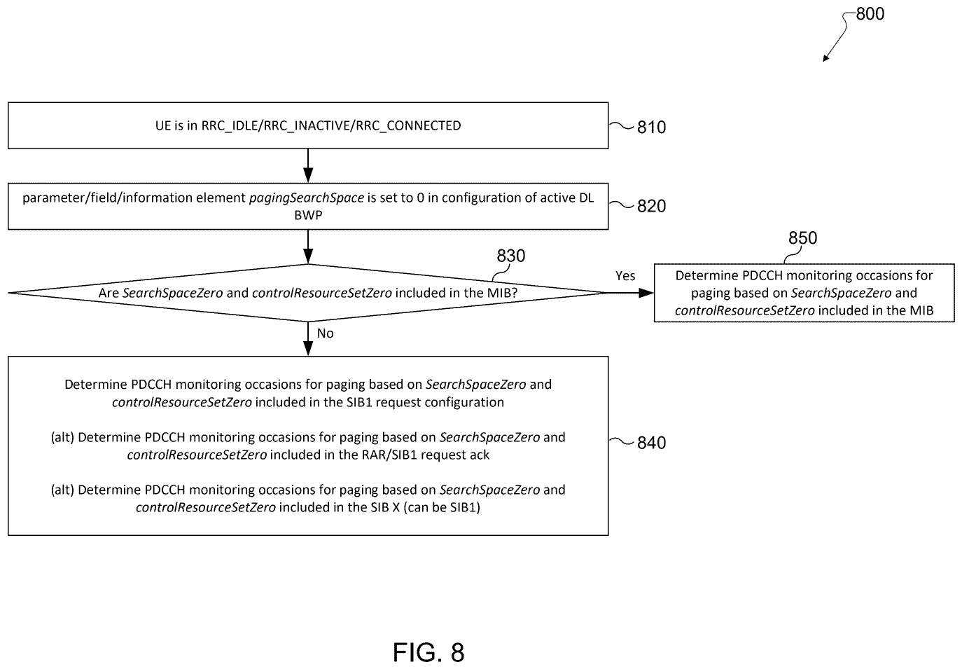

FIG. 8 illustrates an example procedure 800 for determining PDCCH monitoring occasions for paging according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for determining PDCCH monitoring occasions for paging could be used without departing from the scope of this disclosure.

In the example of FIG. 8, procedure 800 begins at operation 810. At operation 810, a UE (such as UE 116 of FIG. 1) may be in an RRC_IDLE/RRC_INACTIVE/RRC_CONNECTED state in a cell. The cell may also be referred to as a camped cell or PCell.

At operation 820, a parameter/field/information element pagingSearchSpace is included in a configuration of an active DL BWP received by the UE from the cell. pagingSearchSpace is set to 0. The BWP configuration is received in system information (e.g., SIB1) and/or an RRC message (e.g., an RRCReconfiguration message) from the network (e.g., a gNB of the cell). The active DL BWP can be a non-RedCap specific initial downlink BWP or a RedCap specific initial downlink BWP or any BWP other than the initial downlink BWP (RedCap/non-RedCap).

In some embodiments, at operation 830, the UE checks whether the parameters SearchSpaceZero and controlResourceSetZero are included in a MIB received from the cell. The MIB can be the latest received MIB from the cell. If the parameters SearchSpaceZero and controlResourceSetZero are not included in the MIB, procedure 800 proceeds to operation 840. Otherwise, if the parameters SearchSpaceZero and controlResourceSetZero are included in the MIB, procedure 800 proceeds to operation 850.

Alternately, in some embodiments, at operation 830, the UE checks whether SIB1 is provided on demand (i.e., based on a SIB1 request) in the cell. If SIB1 is provided on demand, procedure 800 proceeds to operation 840. Otherwise, if SIB1 is not provided on demand, MIB, procedure 800 proceeds to operation 850. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1 and a SIB1 request configuration is available for the cell.

In some embodiments, at operation 840, SearchSpaceZero and controlResourceSetZero can be included in a SIB1 request configuration. In these embodiments, the UE determines the PDCCH monitoring occasions and CORESET for paging based on SearchSpaceZero and controlResourceSetZero included in the SIB1 request configuration of the cell (or valid SIB1 request configuration of the cell). The SIB1 request configuration of the cell can be received by the UE from another cell. The SIB1 request configuration of the cell can be received by the UE from another cell before camping to the cell. The SIB1 request configuration of the cell can be received by the UE from the cell.

Alternately, in some embodiments, at operation 840, SearchSpaceZero and controlResourceSetZero can be included in a RAR/SIB1 request acknowledgement (ACK). In these embodiments, the UE determines the PDCCH monitoring occasions and CORESET for paging based on SearchSpaceZero and controlResourceSetZero included in the RAR/SIB1 request ACK. If SIB1 is provided on demand in the cell, the UE transmits a SIB1 request (e.g., the UE transmits a RACH preamble using a dedicated RACH resources for the SIB1 request) to the cell and in response receives a RAR/SIB1 request ACK. The UE can store the SearchSpaceZero and controlResourceSetZero included in the RAR/SIB1 request ACK and later use the SearchSpaceZero and controlResourceSetZero included in the RAR/SIB1 request ACK to determine PDCCH monitoring occasions for paging.

Alternately, in some embodiments, at operation 840, SearchSpaceZero and controlResourceSetZero can be included in some SIB (e.g., SIB X or SIB1) of the cell. In these embodiments, the UE determines the PDCCH monitoring occasions and CORESET for paging based on SearchSpaceZero and controlResourceSetZero included in some SIB (e.g., SIB X or SIB1) of the cell.

At operation 850, the UE determines the PDCCH monitoring occasions and CORESET for paging based on SearchSpaceZero and controlResourceSetZero included in the MIB.

These determined PDCCH monitoring occasions for paging are then grouped in POs (as explained herein above) and the UE monitors the PDCCH monitoring occasions for paging in the UEs PO.

Although FIG. 8 illustrates one example procedure 800 for determining PDCCH monitoring occasions for paging, various changes may be made to FIG. 8. For example, while shown as a series of operations, various operations in FIG. 8 could overlap, occur in parallel, occur in a different order, occur any number of times, be omitted, or be replaced by other operations.

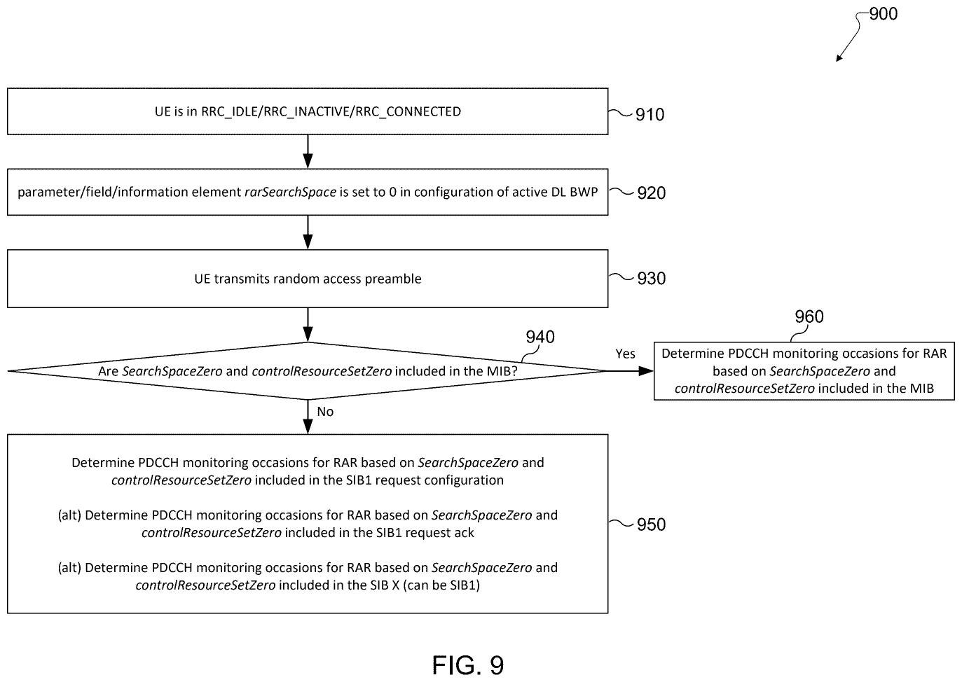

FIG. 9 illustrates an example procedure 900 for determining PDCCH monitoring occasions for RAR according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for determining PDCCH monitoring occasions for RAR could be used without departing from the scope of this disclosure.

In the example of FIG. 9, procedure 900 begins at operation 910. At operation 910, a UE (such as UE 116 of FIG. 1) may be in an RRC_IDLE/RRC_INACTIVE/RRC_CONNECTED state in a cell. The cell may also be referred to as a camped cell or PCell.

At operation 920, a parameter/field/information element rarSearchSpace is included in a configuration of an active DL BWP received by the UE from the cell. rarSearchSpace is set to 0. The BWP configuration is received in system information (e.g., SIB1) and/or an RRC message (e.g., an RRCReconfiguration message) from the network (e.g., a gNB of the cell). The active DL BWP can be a non-RedCap specific initial downlink BWP or a RedCap specific initial downlink BWP or any BWP other than the initial downlink BWP (RedCap/non-RedCap).

At operation 930, the UE transmits a random access preamble to the cell. This random access preamble transmission is for a reason other than a SIB1 request.

In some embodiments, at operation 940, the UE checks whether the parameters SearchSpaceZero and controlResourceSetZero are included in a MIB received from the cell. The MIB can be the latest received MIB from the cell. If the parameters SearchSpaceZero and controlResourceSetZero are not included in the MIB, procedure 900 proceeds to operation 950. Otherwise, if the parameters SearchSpaceZero and controlResourceSetZero are included in the MIB, procedure 900 proceeds to operation 960.

Alternately, in some embodiments, at operation 940, the UE checks whether SIB1 is provided on demand (i.e., based on SIB1 request) in the cell). If SIB1 is provided on demand, procedure 900 proceeds to operation 950. Otherwise, if SIB1 is not provided on demand, MIB, procedure 900 proceeds to operation 960. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1 and a SIB1 request configuration is available for the cell.

In some embodiments, at operation 950, SearchSpaceZero and controlResourceSetZero can be included in a SIB1 request configuration. In these embodiments, the UE determines the PDCCH monitoring occasions and CORESET for RAR based on SearchSpaceZero and controlResourceSetZero included in the SIB1 request configuration of the cell (or valid SIB1 request configuration of the cell). The SIB1 request configuration of the cell can be received by the UE from another cell. The SIB1 request configuration of the cell can be received by the UE from another cell before camping to the cell. The SIB1 request configuration of the cell can be received by the UE from the cell.

Alternately, in some embodiments, at operation 950, SearchSpaceZero and controlResourceSetZero can be included in a SIB1 request ACK. In these embodiments, the UE determines the PDCCH monitoring occasions and CORESET for RAR based on SearchSpaceZero and controlResourceSetZero included in the SIB1 request ACK. If SIB1 is provided on demand in the cell, the UE transmits a SIB1 request (e.g., the UE transmits a RACH preamble using a dedicated RACH resources for the SIB1 request) to the cell and in response receives a RAR/SIB1 request ACK. The UE can store the SearchSpaceZero and controlResourceSetZero included in the SIB1 request ACK and later use the SearchSpaceZero and controlResourceSetZero included in the RAR/SIB1 request ACK to determine PDCCH monitoring occasions for RAR.

Alternately, in some embodiments, at operation 950, SearchSpaceZero and controlResourceSetZero can be included in some SIB (e.g., SIB X or SIB1) of the cell. In these embodiments, the UE determines the PDCCH monitoring occasions and CORESET for RAR based on SearchSpaceZero and controlResourceSetZero included in some SIB (e.g., SIB X or SIB1) of the cell.

At operation 960, the UE determines the PDCCH monitoring occasions and CORESET for RAR based on SearchSpaceZero and controlResourceSetZero included in the MIB.

Amongst these determined PDCCH monitoring occasions, PDCCH monitoring occasions which occur during the RAR window are monitored by the UE for receiving the RAR.

Although FIG. 9 illustrates one example procedure 900 for determining PDCCH monitoring occasions for RAR, various changes may be made to FIG. 9. For example, while shown as a series of operations, various operations in FIG. 9 could overlap, occur in parallel, occur in a different order, occur any number of times, be omitted, or be replaced by other operations.

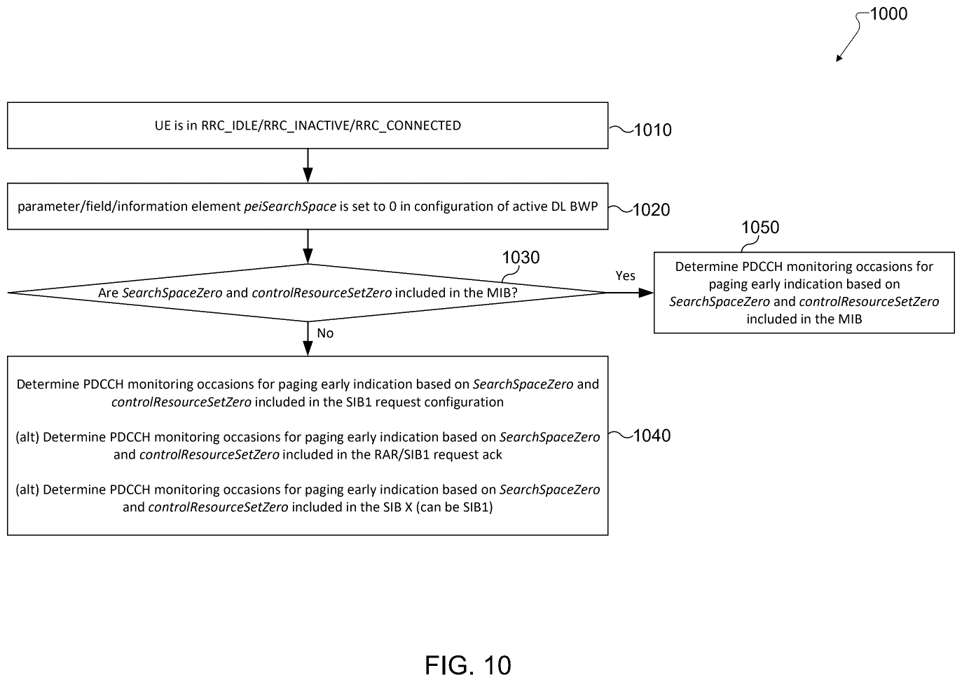

FIG. 10 illustrates an example procedure 1000 for determining PDCCH monitoring occasions for paging early indication according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for determining PDCCH monitoring occasions for paging early indication could be used without departing from the scope of this disclosure.

In the example of FIG. 10, procedure 1000 begins at operation 1010. At operation 1010, a UE (such as UE 116 of FIG. 1) may be in an RRC_IDLE/RRC_INACTIVE/RRC_CONNECTED state in a cell. The cell may also be referred to as a camped cell or PCell.

At operation 1020, a parameter/field/information element peiSearchSpace is included in the configuration of an active DL BWP received from the cell. peiSearchSpace is set to 0. The BWP configuration is received in system information (e.g., SIB1) and/or an RRC message (e.g., RRCReconfiguration message) from the network (e.g., a gNB of the cell). The active DL BWP can be a non-RedCap specific initial downlink BWP or a RedCap specific initial downlink BWP or BWP other than the initial downlink BWP (RedCap/non-RedCap).

In some embodiments, at operation 1030, the UE checks whether the parameters SearchSpaceZero and controlResourceSetZero are included in the MIB received from the cell. The MIB can be the latest received MIB from the cell. If the parameters SearchSpaceZero and controlResourceSetZero are not included in the MIB, procedure 1000 proceeds to operation 1040. Otherwise, if the parameters SearchSpaceZero and controlResourceSetZero are included in the MIB, procedure 1000 proceeds to operation 1060.

Alternately, in some embodiments, at operation 1030, the UE checks whether SIB1 is provided on demand (i.e., based on a SIB1 request) in the cell. If SIB1 is provided on demand, procedure 1000 proceeds to operation 1040. Otherwise, if SIB1 is not provided on demand, MIB, procedure 1000 proceeds to operation 1050. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1 and a SIB1 request configuration is available for the cell.

In some embodiments, at operation 1040, SearchSpaceZero and controlResourceSetZero can be included in a SIB1 request configuration. In these embodiments, the UE determines the PDCCH monitoring occasions and CORESET for paging early indication based on SearchSpaceZero and controlResourceSetZero included in the SIB1 request configuration of the cell (or valid SIB1 request configuration of the cell). The SIB1 request configuration of the cell can be received by the UE from another cell. The SIB1 request configuration of the cell can be received by the UE from another cell before camping to the cell. The SIB1 request configuration of the cell can be received by the UE from the cell.

Alternately, in some embodiments, at operation 1040, SearchSpaceZero and controlResourceSetZero can be included in a RAR/SIB1 request ACK. In these embodiments, the UE determines the PDCCH monitoring occasions and CORESET for paging early indication based on SearchSpaceZero and controlResourceSetZero included in the RAR/SIB1 request ACK. If SIB1 is provided on demand in the cell, the UE transmits a SIB1 request (e.g., the UE transmits a RACH preamble using dedicated RACH resources for the SIB1 request) to the cell and in response receive RAR/SIB1 request ACK. UE can store SearchSpaceZero and controlResourceSetZero included in RAR/SIB1 request ACK and later use the SearchSpaceZero and controlResourceSetZero to determine PDCCH monitoring occasions for paging early indication.

Alternately, in some embodiments, at operation 1040, SearchSpaceZero and controlResourceSetZero can be included in some SIB (e.g., SIB X or SIB1) of the cell. In these embodiments, the UE determines the PDCCH monitoring occasions and CORESET for paging early indication based on SearchSpaceZero and controlResourceSetZero included in some SIB (e.g., SIB X or SIB1) of the cell.

At operation 1050, the UE determines the PDCCH monitoring occasions and CORESET for paging early indication based on SearchSpaceZero and controlResourceSetZero included in the MIB.

These determined PDCCH monitoring occasions for paging early indications before the UE's PF/PO (as explained above herein) are monitored by the UE for receiving a paging early indication.

Although FIG. 10 illustrates one example procedure 1000 for determining PDCCH monitoring occasions for paging early indication, various changes may be made to FIG. 10. For example, while shown as a series of operations, various operations in FIG. 10 could overlap, occur in parallel, occur in a different order, occur any number of times, be omitted, or be replaced by other operations.

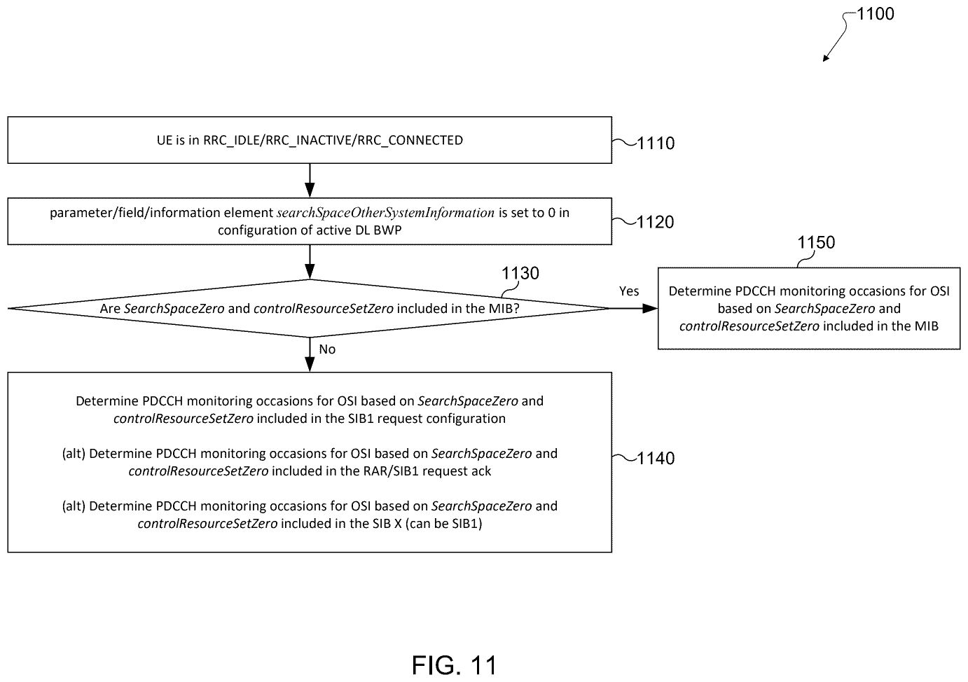

FIG. 11 illustrates an example procedure 1100 for determining PDCCH monitoring occasions for OSI according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for determining PDCCH monitoring occasions for OSI could be used without departing from the scope of this disclosure.

In the example of FIG. 11, procedure 1100 begins at operation 1110. At operation 1110, a UE (such as UE 116 of FIG. 1) may be in an RRC_IDLE/RRC_INACTIVE/RRC_CONNECTED state in a cell. The cell may also be referred to as a camped cell or PCell.

At operation 1120, a parameter/field/information element searchSpaceOtherSystemInformation is included in a configuration of an active DL BWP received by the UE from the cell. searchSpaceOtherSystemInformation is set to 0. The BWP configuration is received in system information (e.g., SIB1) and/or an RRC message (e.g., an RRCReconfiguration message) from the network (e.g., a gNB of the cell). The active DL BWP can be a non-RedCap specific initial downlink BWP or a RedCap specific initial downlink BWP or any BWP other than the initial downlink BWP (RedCap/non-RedCap).

In some embodiments, at operation 1130, the UE checks whether the parameters SearchSpaceZero and controlResourceSetZero are included in a MIB received from the cell. The MIB can be the latest received MIB from the cell. If the parameters SearchSpaceZero and controlResourceSetZero are not included in the MIB, procedure 1100 proceeds to operation 1140. Otherwise, if the parameters SearchSpaceZero and controlResourceSetZero are included in the MIB, procedure 1100 proceeds to operation 1150.

Alternately, in some embodiments, at operation 1130, the UE checks whether SIB1 is provided on demand (i.e., based on SIB1 request) in the cell). If SIB1 is provided on demand, procedure 1100 proceeds to operation 1140. Otherwise, if SIB1 is not provided on demand, MIB, procedure 1100 proceeds to operation 1150. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1 and a SIB1 request configuration is available for the cell.

In some embodiments, at operation 1140, SearchSpaceZero and controlResourceSetZero can be included in a SIB1 request configuration. In these embodiments, the UE determines the PDCCH monitoring occasions and CORESET for OSI based on SearchSpaceZero and controlResourceSetZero included in the SIB1 request configuration of the cell (or valid SIB1 request configuration of the cell). The SIB1 request configuration of the cell can be received by the UE from another cell. The SIB1 request configuration of the cell can be received by the UE from another cell before camping to the cell. The SIB1 request configuration of the cell can be received by the UE from the cell.

Alternately, in some embodiments, at operation 1140, SearchSpaceZero and controlResourceSetZero can be included in a RAR/SIB1 request ACK. In these embodiments, the UE determines the PDCCH monitoring occasions and CORESET for OSI based on SearchSpaceZero and controlResourceSetZero included in the RAR/SIB1 request ACK. If SIB1 is provided on demand in the cell, the UE transmits a SIB1 request (e.g., the UE transmits a RACH preamble using a dedicated RACH resources for the SIB1 request) to the cell and in response receives a RAR/SIB1 request ACK. The UE can store the SearchSpaceZero and controlResourceSetZero included in the RAR/SIB1 request ACK and later use the SearchSpaceZero and controlResourceSetZero included in the RAR/SIB1 request ACK to determine PDCCH monitoring occasions for OSI.

Alternately, in some embodiments, at operation 1140, SearchSpaceZero and controlResourceSetZero can be included in some SIB (e.g., SIB X or SIB1) of the cell. In these embodiments, the UE determines the PDCCH monitoring occasions and CORESET for OSI based on SearchSpaceZero and controlResourceSetZero included in some SIB (e.g., SIB X or SIB1) of the cell.

At operation 1150, the UE determines the PDCCH monitoring occasions and CORESET for OSI based on SearchSpaceZero and controlResourceSetZero included in the MIB.

These determined PDCCH monitoring occasions for OSI in the SI window are monitored by the UE for receiving OSI.

Although FIG. 11 illustrates one example procedure 1100 for determining PDCCH monitoring occasions for OSI, various changes may be made to FIG. 11. For example, while shown as a series of operations, various operations in FIG. 11 could overlap, occur in parallel, occur in a different order, occur any number of times, be omitted, or be replaced by other operations.

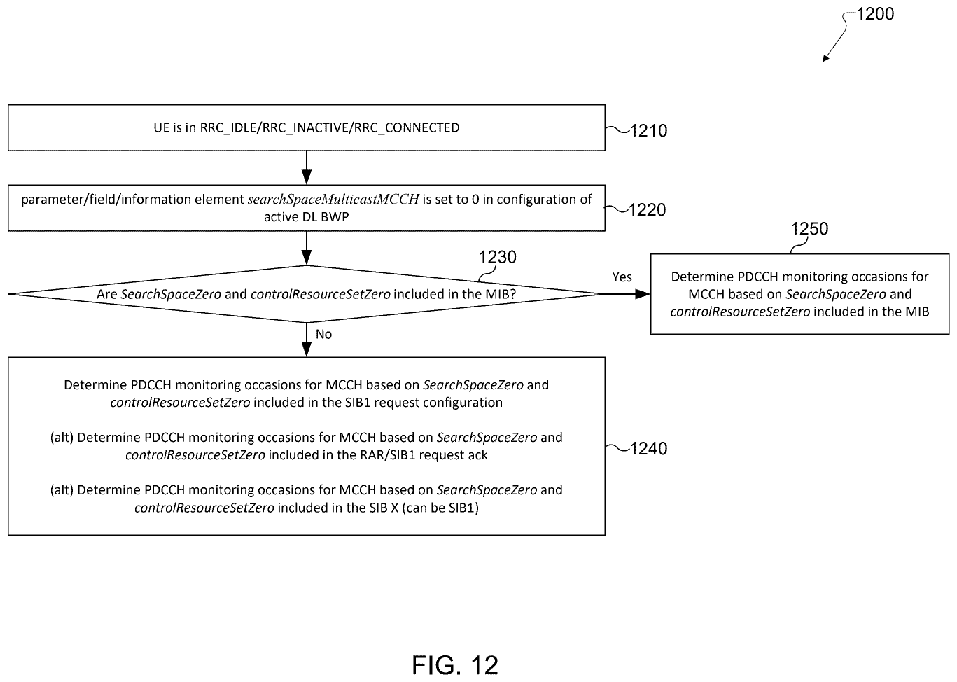

FIG. 12 illustrates an example procedure 1200 for determining PDCCH monitoring occasions for MCCH according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for determining PDCCH monitoring occasions for MCCH could be used without departing from the scope of this disclosure.

In the example of FIG. 12, procedure 1200 begins at operation 1210. At operation 1210, a UE (such as UE 116 of FIG. 1) may be in an RRC_IDLE/RRC_INACTIVE/RRC_CONNECTED state in a cell. The cell may also be referred to as a camped cell or PCell.

At operation 1220, a parameter/field/information element searchSpaceMulticastMCCH is included in a configuration of an active DL BWP received by the UE from the cell. searchSpaceMulticastMCCH is set to 0. The BWP configuration is received in system information (e.g., SIB1) and/or an RRC message (e.g., an RRCReconfiguration message) from the network (e.g., a gNB of the cell). The active DL BWP can be a non-RedCap specific initial downlink BWP or a RedCap specific initial downlink BWP or any BWP other than the initial downlink BWP (RedCap/non-RedCap).

In some embodiments, at operation 1230, the UE checks whether the parameters SearchSpaceZero and controlResourceSetZero are included in a MIB received from the cell. The MIB can be the latest received MIB from the cell. If the parameters SearchSpaceZero and controlResourceSetZero are not included in the MIB, procedure 1200 proceeds to operation 1240. Otherwise, if the parameters SearchSpaceZero and controlResourceSetZero are included in the MIB, procedure 1200 proceeds to operation 1250.

Alternately, in some embodiments, at operation 1230, the UE checks whether SIB1 is provided on demand (i.e., based on SIB1 request) in the cell. If SIB1 is provided on demand, procedure 1200 proceeds to operation 1240. Otherwise, if SIB1 is not provided on demand, MIB, procedure 1200 proceeds to operation 1250. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g. 24) for FR1 and a SIB1 request configuration is available for the cell.

In some embodiments, at operation 1240, SearchSpaceZero and controlResourceSetZero can be included in a SIB1 request configuration. In these embodiments, the UE determines the PDCCH monitoring occasions and CORESET for MCCH based on SearchSpaceZero and controlResourceSetZero included in the SIB1 request configuration of the cell (or valid SIB1 request configuration of the cell). The SIB1 request configuration of the cell can be received by the UE from another cell. The SIB1 request configuration of the cell can be received by the UE from another cell before camping to the cell. The SIB1 request configuration of the cell can be received by the UE from the cell.

Alternately, in some embodiments, at operation 1240, SearchSpaceZero and controlResourceSetZero can be included in a RAR/SIB1 request ACK. In these embodiments, the UE determines the PDCCH monitoring occasions and CORESET for MCCH based on SearchSpaceZero and controlResourceSetZero included in the RAR/SIB1 request ACK. If SIB1 is provided on demand in the cell, the UE transmits a SIB1 request (e.g., the UE transmits a RACH preamble using a dedicated RACH resources for the SIB1 request) to the cell and in response receives a RAR/SIB1 request ACK. The UE can store the SearchSpaceZero and controlResourceSetZero included in the RAR/SIB1 request ACK and later use the SearchSpaceZero and controlResourceSetZero included in the RAR/SIB1 request ACK to determine PDCCH monitoring occasions for MCCH.

Alternately, in some embodiments, at operation 1240, SearchSpaceZero and controlResourceSetZero can be included in some SIB (e.g., SIB X or SIB1) of the cell. In these embodiments, the UE determines the PDCCH monitoring occasions and CORESET for MCCH based on SearchSpaceZero and controlResourceSetZero included in some SIB (e.g., SIB X or SIB1) of the cell.

At operation 1250, the UE determines the PDCCH monitoring occasions and CORESET for MCCH based on SearchSpaceZero and controlResourceSetZero included in the MIB.

These determined PDCCH monitoring occasions for MCCH in the MCCH transmission window are monitored by the UE for receiving MCCH.

Although FIG. 12 illustrates one example procedure 1200 for determining PDCCH monitoring occasions for MCCH, various changes may be made to FIG. 12. For example, while shown as a series of operations, various operations in FIG. 12 could overlap, occur in parallel, occur in a different order, occur any number of times, be omitted, or be replaced by other operations.

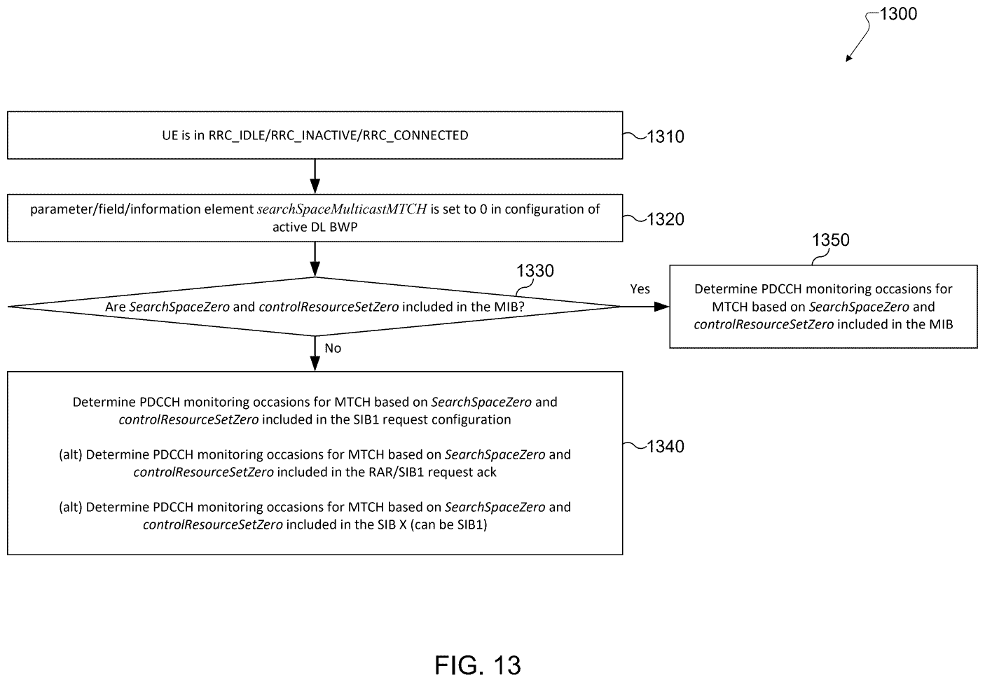

FIG. 13 illustrates an example procedure 1300 for determining PDCCH monitoring occasions for MTCH according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for determining PDCCH monitoring occasions for MTCH could be used without departing from the scope of this disclosure.

In the example of FIG. 13, procedure 1300 begins at operation 1310. At operation 1310, a UE (such as UE 116 of FIG. 1) may be in an RRC_IDLE/RRC_INACTIVE/RRC_CONNECTED state in a cell. The cell may also be referred to as a camped cell or PCell.

At operation 1320, a parameter/field/information element searchSpaceMulticastMTCH is included in a configuration of an active DL BWP received by the UE from the cell. searchSpaceMulticastMTCHis set to 0. The BWP configuration is received in system information (e.g., SIB1) and/or an RRC message (e.g., an RRCReconfiguration message) from the network (e.g., a gNB of the cell). The active DL BWP can be a non-RedCap specific initial downlink BWP or a RedCap specific initial downlink BWP or any BWP other than the initial downlink BWP (RedCap/non-RedCap).

In some embodiments, at operation 1330, the UE checks whether the parameters SearchSpaceZero and controlResourceSetZero are included in a MIB received from the cell. The MIB can be the latest received MIB from the cell. If the parameters SearchSpaceZero and controlResourceSetZero are not included in the MIB, procedure 1300 proceeds to operation 1340. Otherwise, if the parameters SearchSpaceZero and controlResourceSetZero are included in the MIB, procedure 1300 proceeds to operation 1350.

Alternately, in some embodiments, at operation 1330, the UE checks whether SIB1 is provided on demand (i.e., based on SIB1 request) in the cell). If SIB1 is provided on demand, procedure 1300 proceeds to operation 1340. Otherwise, if SIB1 is not provided on demand, MIB, procedure 1300 proceeds to operation 1350. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1. In some embodiments, SIB1 may be provided on demand (i.e., based on a SIB1 request) in the cell if the kssb/ssb-SubcarrierOffset in the MIB of the cell is set to one of values greater than or equal to a pre-defined value (e.g., 12) for FR2 or one of values greater than or equal to a pre-defined value (e.g., 24) for FR1 and a SIB1 request configuration is available for the cell.

In some embodiments, at operation 1340, SearchSpaceZero and controlResourceSetZero can be included in a SIB1 request configuration. In these embodiments, the UE determines the PDCCH monitoring occasions and CORESET for MTCH based on SearchSpaceZero and controlResourceSetZero included in the SIB1 request configuration of the cell (or valid SIB1 request configuration of the cell). The SIB1 request configuration of the cell can be received by the UE from another cell. The SIB1 request configuration of the cell can be received by the UE from another cell before camping to the cell. The SIB1 request configuration of the cell can be received by the UE from the cell.

Alternately, in some embodiments, at operation 1340, SearchSpaceZero and controlResourceSetZero can be included in a RAR/SIB1 request ACK. In these embodiments, the UE determines the PDCCH monitoring occasions and CORESET for MTCH based on SearchSpaceZero and controlResourceSetZero included in the RAR/SIB1 request ACK. If SIB1 is provided on demand in the cell, the UE transmits a SIB1 request (e.g., the UE transmits a RACH preamble using a dedicated RACH resources for the SIB1 request) to the cell and in response receives a RAR/SIB1 request ACK. The UE can store the SearchSpaceZero and controlResourceSetZero included in the RAR/SIB1 request ACK and later use the SearchSpaceZero and controlResourceSetZero included in the RAR/SIB1 request ACK to determine PDCCH monitoring occasions for MTCH.

Alternately, in some embodiments, at operation 1340, SearchSpaceZero and controlResourceSetZero can be included in some SIB (e.g., SIB X or SIB1) of the cell. In these embodiments, the UE determines the PDCCH monitoring occasions and CORESET for MTCH based on SearchSpaceZero and controlResourceSetZero included in some SIB (e.g., SIB X or SIB1) of the cell.

At operation 1350, the UE determines the PDCCH monitoring occasions and CORESET for MTCH based on SearchSpaceZero and controlResourceSetZero included in the MIB.

These determined PDCCH monitoring occasions for MTCH in the MTCH transmission window are monitored by UE for receiving MTCH.

Although FIG. 13 illustrates one example procedure 1300 for determining PDCCH monitoring occasions for MTCH, various changes may be made to FIG. 13. For example, while shown as a series of operations, various operations in FIG. 13 could overlap, occur in parallel, occur in a different order, occur any number of times, be omitted, or be replaced by other operations.

In some embodiments, while a UE is in an RRC_CONNECTED state and timer T311 is running (T311 is started upon initiating the RRC connection re-establishment procedure), if the selected cell during the connection re-establishment provides SIB1 on demand and SIB1 request is not supported in the RRC_CONNECTED state, the UE shall bar the selected cell or not select this cell during connection re-establishment.

Alternately, in some embodiments, while the UE is in an RRC_CONNECTED state and timer T311 is running (T311 is started upon initiating the RRC connection re-establishment procedure), if the selected cell during the connection re-establishment provides SIB1 on demand and if the UE has a SIB1 request configuration of the selected cell, the UE can send a SIB1 request (e.g., RACH preamble using dedicated RACH resources for SIB1 request) to the selected cell. If the UE does not have a SIB1 request configuration of the selected cell, the UE shall bar the selected cell.

Alternately, in some embodiments, while the UE is in an RRC_CONNECTED state and timer T311 is running (T311 is started upon initiating the RRC connection re-establishment procedure), if the selected cell during the connection re-establishment provides SIB1 on demand and if the UE has a SIB1 request configuration of the selected cell and SIB1 request is supported in the RRC_CONNECTED state (this may be indicated by the network [gNB] in an RRC message or SI), the UE can send a SIB1 request (e.g., a RACH preamble using dedicated RACH resources for SIB1 request) to the selected cell. Otherwise, the UE shall bar the selected cell.

Alternately, in some embodiments, if the UE is in RRC_CONNECTED with an active BWP with common search space configured by searchSpaceSIBI and the UE has not stored a valid version of a SIB or posSIB, of one or several required SIB(s) or posSIB(s), and, UE has not acquired SIB1 in current modification period; or if the UE is in RRC_CONNECTED with an active BWP with common search space configured by searchSpaceSIBI, and, the UE has not stored a valid version of a SIB or posSIB, of one or several required SIB(s) or posSIB(s), and, si-BroadcastStatus for the required SIB(s) or posSI-BroadcastStatus for the required posSIB(s) is set to notBroadcasting in acquired SIB1 in current modification period:
If SIB1 is not periodically broadcast (or provided on demand based on a SIB1 request):
   Option 1: the UE sends SIB1 request.
      a DedicatedSIBRequest or new RRC message can be used for the SIB1 request
      the UE can send the SIB1 request (e.g., a RACH preamble using dedicated RACH resources for the SIB1 request)
      whether the UE can send the SIB1 request in an RRC_CONNECTED state can be signaled by the network in an RRC message.
   Option 2: the UE does not send SIB1 request. The UE relies on the network to provide the latest SIB1 via an RRC message. The network may send SIB1 in a dedicated manner to the UE every modification period. Alternately, the network may send a change notification for si-BroadcastStatus changes if the cell supports on demand SIB1 and the UE receives SIB1 upon receiving a change notification. Alternatively, a new notification in a short message or DCI for si-BroadcastStatus changes can be included.

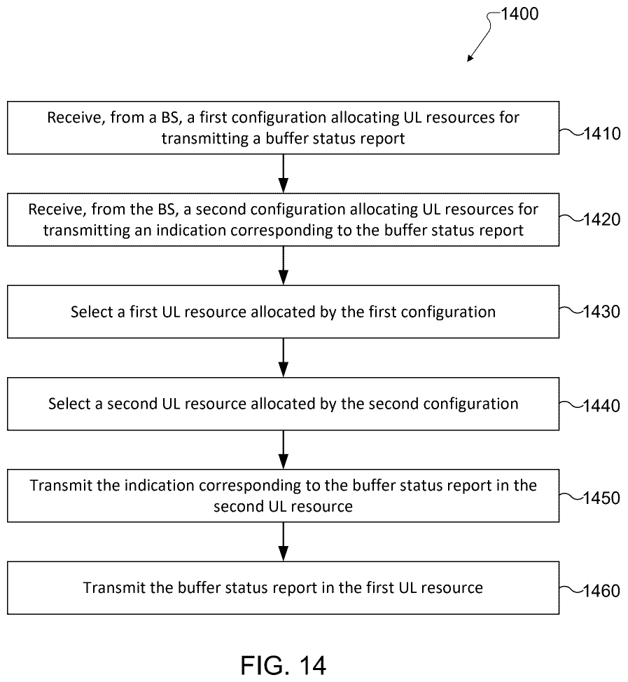

FIG. 14 illustrates an example method 1400 for buffer status reporting according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for buffer status reporting could be used without departing from the scope of this disclosure.

In the example of FIG. 14, method 1400 begins at step 1410. At step 1410, a UE (such as UE 116 of FIG. 1) receives, from a BS (such as gNB 102 of FIG. 1), a first configuration allocating UL resources for transmitting a buffer status report.

At step 1420, the UE receives, from the BS, a second configuration allocating UL resources for transmitting an indication corresponding to the buffer status report.

In some embodiments, the UL resources allocated by the first configuration may be PUSCH resources, and the UL resources allocated by the second configuration may be one of PUSCH resources and PUCCH resources.

In some embodiments, the resources for transmitting the buffer status report and the resources for transmitting the indication corresponding to the buffer status report may be periodically occurring resources.

At step 1430, the UE selects a first UL resource allocated by the first configuration;

At step 1440, the UE selects a second UL resource allocated by the second configuration.

At step 1450, the UE transmits the indication corresponding to the buffer status report in the second UL resource. In some embodiments, the indication may indicate at least one of transmission of the status report in the first UL resource, and an identity of the first UL resource.

At step 1460, the UE transmits the buffer status report in the first UL resource.

In some embodiments, the buffer status report may be transmitted in the first UL resource after transmitting the indication corresponding to the buffer status report in the second UL resource, and the second resource may be at least one of a latest available UL resource allocated by the second configuration occurring before the first resource, and a latest available UL resource allocated by the second configuration occurring before an offset from the first resource.

In some embodiments, the indication corresponding to the buffer status report may be transmitted in the second UL resource in response to a trigger for the buffer status report, and the first UL resource may be at least one of a nearest available UL resource allocated by the first configuration occurring after the trigger for the buffer status report, a first available UL resource allocated by the first configuration occurring after an offset from the trigger for the buffer status report, and a first available UL resource allocated by the first configuration occurring after the second UL resource in which the indication is transmitted.

In some embodiments, a plurality of UL resources allocated by the first configuration may be associated with an UL resource allocated by the second configuration, and the UE may sequentially index the plurality of UL resources allocated by the first configuration that are associated with the UL resource allocated by the second configuration.

Although FIG. 14 illustrates one example method 1400 for buffer status reporting, various changes may be made to FIG. 14. For example, while shown as a series of steps, various steps in FIG. 14 could overlap, occur in parallel, occur in a different order, occur any number of times, be omitted, or replaced by other steps.

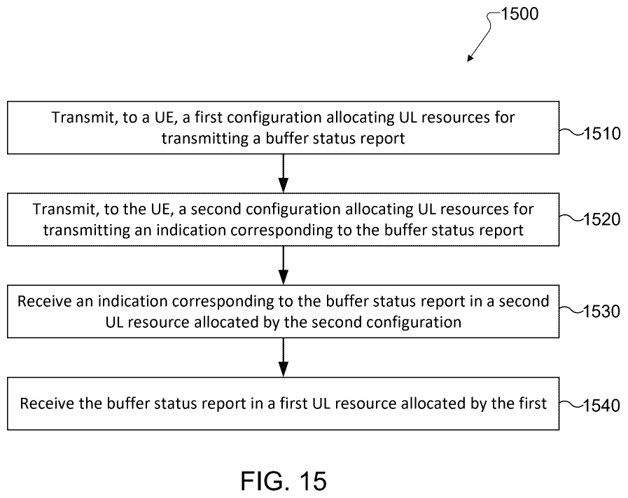

FIG. 15 illustrates another example method 1500 for buffer status reporting according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for buffer status reporting could be used without departing from the scope of this disclosure.

In the example of FIG. 15, method 1500 begins at step 1510. At step 1510, a BS (such as gNB 102 of FIG. 1) transmits, to a UE (such as UE 116 of FIG. 1), a first configuration allocating UL resources for transmitting a buffer status report.

At step 1520, the BS transmits, to the UE, a second configuration allocating UL resources for transmitting an indication corresponding to the buffer status report.

In some embodiments, the UL resources allocated by the first configuration may be PUSCH resources, and the UL resources allocated by the second configuration may be one of PUSCH resources and PUCCH resources.

In some embodiments, the resources for transmitting the buffer status report and the resources for transmitting the indication corresponding to the buffer status report may be periodically occurring resources.

At step 1530, the BS receives an indication corresponding to the buffer status report in a second UL resource allocated by the second configuration.

At step 1540, the BS receives the buffer status report in a first UL resource allocated by the first configuration.

In some embodiments, the indication may indicate at least one of transmission of the status report in the first UL resource, and an identify of the first UL resource.

In some embodiments, the plurality of UL resources allocated by the first configuration may be associated with an UL resource allocated by the second configuration, and the BS may receive the buffer status report in the first UL resource after receiving the indication corresponding to the buffer status report in the second UL resource. The second resource may be at least one of a latest available UL resource allocated by the second configuration occurring before the first resource, and a latest available UL resource allocated by the second configuration occurring before an offset from the first resource.

In some embodiments, the BS may receive the indication corresponding to the buffer status report in the second UL resource in response to a UE trigger for the buffer status report. The first resource may be at least one of a nearest available UL resource allocated by the first configuration occurring after the UE trigger for the buffer status report, a first available UL resource allocated by the first configuration occurring after an offset from the UE trigger for the buffer status report, and a first available UL resource allocated by the first configuration occurring after the second UL resource in which the indication is transmitted.

Although FIG. 15 illustrates one example method 1500 for buffer status reporting, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS), a first configuration allocating uplink (UL) resources for transmitting a buffer status report; and
receive, from the BS, a second configuration allocating UL resources for transmitting an indication corresponding to the buffer status report; and
a processor operably coupled to the transceiver, the processor configured to:
select a first UL resource allocated by the first configuration; and
select a second UL resource allocated by the second configuration,
wherein the transceiver is further configured to:
transmit the indication corresponding to the buffer status report in the second UL resource; and
transmit the buffer status report in the first UL resource.

2. The UE of claim 1, wherein the resources for transmitting the buffer status report and the resources for transmitting the indication corresponding to the buffer status report are periodically occurring resources.

3. The UE of claim 1, wherein the indication indicates at least one of:
transmission of the buffer status report in the first UL resource; and
an identity of the first UL resource.

4. The UE of claim 3, wherein:
a plurality of UL resources allocated by the first configuration are associated with an UL resource allocated by the second configuration; and
the processor is further configured to sequentially index the plurality of UL resources allocated by the first configuration that are associated with the UL resource allocated by the second configuration.

5. The UE of claim 1, wherein:
the transceiver is further configured to transmit the buffer status report in the first UL resource after transmitting the indication corresponding to the buffer status report in the second UL resource; and
the second resource is at least one of:
a latest available UL resource allocated by the second configuration occurring before the first resource; and
a latest available UL resource allocated by the second configuration occurring before an offset from the first resource.

6. The UE of claim 1, wherein:
the transceiver is further configured to transmit the indication corresponding to the buffer status report in the second UL resource in response to a trigger for the buffer status report; and
the first UL resource is at least one of:
a nearest available UL resource allocated by the first configuration occurring after the trigger for the buffer status report;
a first available UL resource allocated by the first configuration occurring after an offset from the trigger for the buffer status report; and
a first available UL resource allocated by the first configuration occurring after the second UL resource in which the indication is transmitted.

7. The UE of claim 1, wherein:
the UL resources allocated by the first configuration are physical uplink shared channel (PUSCH) resources; and
the UL resources allocated by the second configuration are one of PUSCH resources and physical uplink control channel (PUCCH) resources.

8. A base station (BS) comprising:
a processor; and
a transceiver operably coupled to the processor, the transceiver configured to:
transmit, to a user equipment (UE), a first configuration allocating uplink (UL) resources for transmitting a buffer status report;
transmit, to the UE, a second configuration allocating UL resources for transmitting an indication corresponding to the buffer status report;
receive an indication corresponding to the buffer status report in a second UL resource allocated by the second configuration; and
receive the buffer status report in a first UL resource allocated by the first configuration.

9. The BS of claim 8, wherein the resources for transmitting the buffer status report and the resources for transmitting the indication corresponding to the buffer status report are periodically occurring resources.

10. The BS of claim 8, wherein the indication indicates at least one of:
transmission of the buffer status report in the first UL resource; and
an identity of the first UL resource.

11. The BS of claim 10, wherein:
a plurality of UL resources allocated by the first configuration are associated with an UL resource allocated by the second configuration;
the transceiver is further configured to receive the buffer status report in the first UL resource after receiving the indication corresponding to the buffer status report in the second UL resource; and
the second resource is at least one of:
a latest available UL resource allocated by the second configuration occurring before the first resource; and
a latest available UL resource allocated by the second configuration occurring before an offset from the first resource.

12. The BS of claim 8, wherein:
the transceiver is further configured to receive the indication corresponding to the buffer status report in the second UL resource in response to a UE trigger for the buffer status report; and
the first UL resource is at least one of:
a nearest available UL resource allocated by the first configuration occurring after the UE trigger for the buffer status report;
a first available UL resource allocated by the first configuration occurring after an offset from the UE trigger for the buffer status report; and
a first available UL resource allocated by the first configuration occurring after the second UL resource in which the indication is transmitted.

13. The BS of claim 8, wherein:
the UL resources allocated by the first configuration are physical uplink shared channel (PUSCH) resources; and
the UL resources allocated by the second configuration are one of PUSCH resources and physical uplink control channel (PUCCH) resources.

14. A method of operating a user equipment (UE), the method comprising:
receiving, from a base station (BS), a first configuration allocating uplink (UL) resources for transmitting a buffer status report;
receiving, from the BS, a second configuration allocating UL resources for transmitting an indication corresponding to the buffer status report;
selecting a first UL resource allocated by the first configuration;
selecting a second UL resource allocated by the second configuration;
transmitting the indication corresponding to the buffer status report in the second UL resource; and
transmitting the buffer status report in the first UL resource.

15. The method of claim 14, wherein the resources for transmitting the buffer status report and the resources for transmitting the indication corresponding to the buffer status report are periodically occurring resources.

16. The method of claim 14, wherein the indication indicates at least one of:
transmission of the buffer status report in the first UL resource; and
an identity of the first UL resource.

17. The method of claim 16, wherein:
a plurality of UL resources allocated by the first configuration are associated with an UL resource allocated by the second configuration; and
the method further comprises sequentially indexing the plurality of UL resources allocated by the first configuration that are associated with the UL resource allocated by the second configuration.

18. The method of claim 14, further wherein:
the buffer status report is transmitted in the first UL resource after transmitting the indication corresponding to the buffer status report in the second UL resource; and
the second resource is at least one of:
a latest available UL resource allocated by the second configuration occurring before the first resource; and
a latest available UL resource allocated by the second configuration occurring before an offset from the first resource.

19. The method of claim 14, wherein:
the indication corresponding to the buffer status report is transmitted in the second UL resource in response to a trigger for the buffer status report; and
the first UL resource is at least one of:
a nearest available UL resource allocated by the first configuration occurring after the trigger for the buffer status report;
a first available UL resource allocated by the first configuration occurring after an offset from the trigger for the buffer status report; and
a first available UL resource allocated by the first configuration occurring after the second UL resource in which the indication is transmitted.

20. The method of claim 14, wherein:
the UL resources allocated by the first configuration are physical uplink shared channel (PUSCH) resources; and
the UL resources allocated by the second configuration are one of PUSCH resources and physical uplink control channel (PUCCH) resources.
